(19) United States
(12) Patent Application Publication
(10) Pub. No.: US 2013/0287294 A1
(43) Pub. Date: Oct. 31, 2013

(54) Methods for Generating Personalized 3D Models Using 2D Images and Generic 3D Models, and Related Personalized 3D Model Generating System

(71) Applicant: CYWEE GROUP LIMITED, Road Town (VG)

(72) Inventors: Zhou Ye, Foster City, CA (US); Ying-Ko Lu, Taoyuan County (TW); Sheng-Wen Jen, Tainan City (TW)

(73) Assignee: Cywee Group Limited, Road Town (VG)

(21) Appl. No.: 13/873,402

(22) Filed: Apr. 30, 2013

Related U.S. Application Data
(60) Provisional application No. 61/640,718, filed on Apr. 30, 2012.

(51) Int. Cl. G06T 17/10

(52) U.S. Cl. CPC G06T 17/10
USPC 382/154

(57) ABSTRACT

A method for generating a personalized 3D model using a plurality of 2D images and a generic 3D model is provided. The method includes the following steps: extracting a plurality of feature points from the plurality of 2D images; extracting a plurality of landmark points from the generic 3D model; mapping the plurality of features extracted from the plurality of 2D images to the plurality of landmark points extracted from the generic 3D model so as to generate relationship parameters for a mapping algorithm; morphing the generic 3D model into a personalized 3D model with the plurality of landmark points, the relationship parameters and the mapping algorithm; iteratively refining the personalized 3D model with the plurality of feature points extracted from the plurality of 2D images; and when a convergent condition is met, the step of iteratively refining the personalized 3D model is complete and the personalized 3D model is saved to the 3D model database.

### CROSS REFERENCE TO RELATED APPLICATIONS

This application claims priority of U.S. Provisional Application No. 61/640,718, filed on Apr. 30, 2012.

### BACKGROUND OF THE INVENTION

1. Field of the Invention

The present invention relates to an animation system, and more particularly, to a method for generating personalized 3D models using 2D images and generic 3D models and an animation system using the same method.

2. Description of the Prior Art

These days 3D movies become more and more popular. Among them, the 3D movie of “Avatar” is well known to people. This movie is regarded as a milestone in 3D filmmaking technology and has become the most popular 3D movie in history.

U.S. Pat. No. 7,646,909 discloses a method in computer system for generating “image set” of an object for recognition. However, U.S. Pat. No. 7,646,909 fails to disclose the features of iteratively refining personalized 3D models with 2D images to meet a convergent condition.

Hence, how to provide an interactive animation system capable of generating personalized 3D models from 2D images and generic 3D models has become an important topic in this field.

### SUMMARY OF THE INVENTION

It is therefore one of the objectives of the present invention to provide a method for generating personalized 3D models using 2D images and generic 3D models and a related animation system using the same method, to solve the above-mentioned problems in the prior art.

According to one aspect of the present invention, a method for generating a personalized 3D model using a plurality of 2D images and a generic 3D model is provided. The method includes the following steps: extracting a plurality of feature points from the plurality of 2D images; extracting a plurality of landmark points from the generic 3D model; mapping the plurality of features extracted from the plurality of 2D images to the plurality of landmark points extracted from the generic 3D model so as to generate relationship parameters using a mapping algorithm; and morphing the generic 3D model into a personalized 3D model with the plurality of landmark points, the relationship parameters and the mapping algorithm.

According to another aspect of the present invention, a method for generating a personalized 3D model using a plurality of 2D images and a generic 3D model is provided. The method includes the following steps: extracting a plurality of feature points from the plurality of 2D images; calculating each rotation of a head of the plurality of 2D images according to the plurality of feature points, a 3D model database and an estimation algorithm; updating incrementally a generic 3D model according to the rotation of the head of the plurality of 2D images at various directions in order to generate an updated 3D model; extracting a plurality of landmark points from the updated 3D model; mapping the plurality of feature points extracted from the plurality of 2D images to the plurality of landmark points extracted from the updated 3D model so as to generate relationship parameters for a mapping algorithm; and morphing the updated 3D model into a personalized 3D model according to the plurality of rotation angles, the relationship parameters, and the mapping algorithm.

According to another aspect of the present invention, a personalized 3D model system is provided. The system includes a 3D model database, a first extractor, a second extractor, a mapping unit, and a morphing unit. The 3D model database is arranged for storing a plurality of generic 3D models. The first extractor is arranged for extracting a plurality of feature points from the plurality of 2D images. The second extractor is arranged for extracting a plurality of landmark points from a selected generic 3D model. The mapping unit is arranged for mapping the plurality of feature points extracted from the plurality of 2D images to the plurality of landmark points extracted from the selected generic 3D model, so as to generate relationship parameters and a mapping algorithm. The morphing unit is arranged for morphing the generic 3D model to generate a personalized 3D model according to the relationship parameters and the mapping algorithm.

By adopting the method for generating personalized 3D models using 2D images and generic 3D models and a related animation system using the same method of the present invention, a 3D model with personalized effects can be achieved. In addition, more 2D images with left/right side views and/or top/down side views can be inputted in order to meet a convergent condition more quickly, which can provide more convenience to users. Besides, by adopting the concept of the present invention, textures can be attached from the plurality of 2D images to the personalized 3D model, which can make the personalized 3D model(s) more lifelike and more accurate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 (including sub-diagrams 1A and 1B) is a diagram showing an animation system according to an embodiment of the present invention.

FIG. 2 (including sub-diagrams 2A and 2B) is a diagram showing a personalized 3D model generating system using 2D image(s) and a generic 3D model according to an embodiment of the present invention.

FIG. 3 is a flow chart illustrating a method for generating personalized 3D models using 2D images and generic 3D models according to an embodiment of the present invention.

FIG. 4 is a diagram illustrating the details of innovative incremental learning method of generating a personalized 3D model using 2D image(s) and a generic 3D model according to an embodiment of the present invention.

FIG. 5 is an overall design flow illustrating the incremental learning method mentioned in FIG. 4.

FIG. 6 is a flow chart illustrating the details for calculating a personalized 3D model by morphing and deformation based on 2D frontal image(s).

FIG. 7 is a flow chart illustrating the details for calculating a personalized 3D model by morphing and deformation based on left/right side view image(s).

FIG. 8 is a flow chart illustrating the details for calculating a personalized 3D model by morphing and deformation based on top/down view image(s).

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

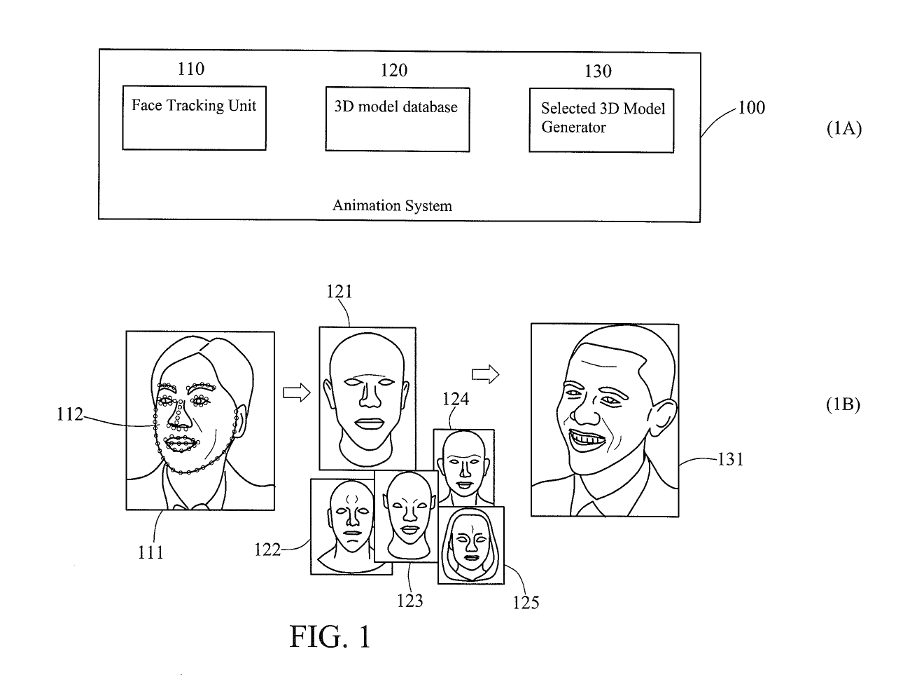

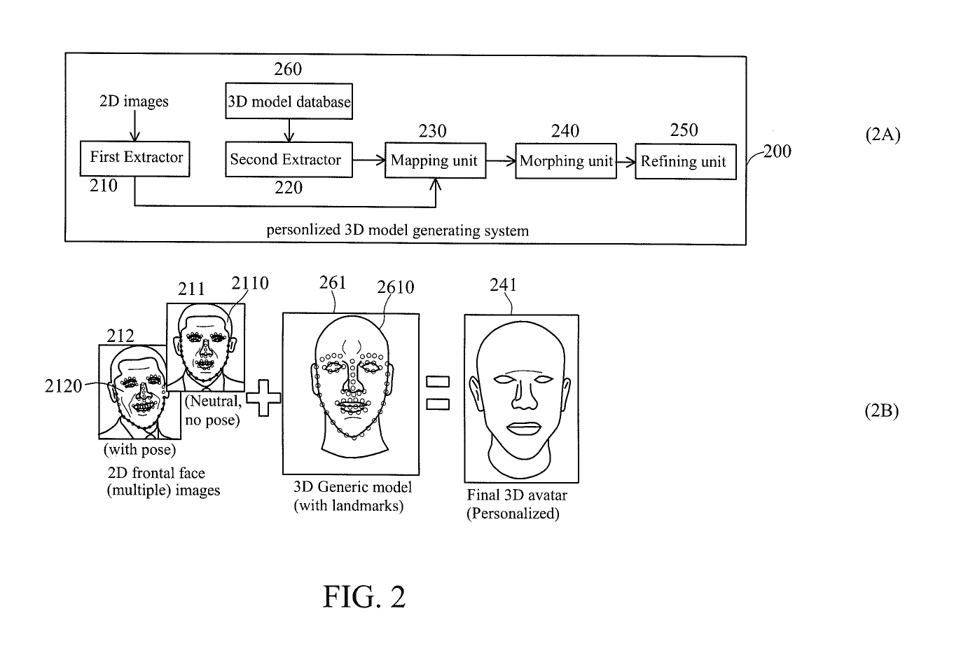

Please refer to FIG. 1. FIG. 1 (including sub-diagrams 1A and 1B) is a diagram showing an animation system 100 according to an embodiment of the present invention. As shown in FIG. 1A, the animation system 100 may include a face tracking unit 110, a 3D model database 120, and a selected 3D model generator 130. The 3D model database 120 stores a plurality of 3D models 121-125 created by this patent (Refer FIG. 2). As shown in FIG. 1B, face tracking is performed on a 2D image 111 and the feature points 112 on the face of the 2D image 111 are obtained by using the face tracking unit 110. The selected 3D model generator 130 generates a 3D model 131 with facial expressions of Barack Obama according to the feature points 112 obtained by the face tracking unit 110 and the 3D model 121 for Barack Obama from the 3D model database 120. As a result, the selected 3D model 131 with facial expressions of Barack Obama can have expression reproduction driven by facial features (i.e., the feature points 112 obtained from the 2D image 111).

Please refer to FIG. 2. FIG. 2 (including sub-diagrams 2A and 2B) is a diagram showing a personalized 3D model generating system 200 using 2D image(s) and a generic 3D model according to an embodiment of the present invention. As shown in FIG. 2A, the system 200 may include a first extractor 210, a second extractor 220, a mapping unit 230, a morphing unit 240, a refining unit 250, and a 3D model database 260. The 3D model database 260 stores a plurality of generic 3D models 120, 261 shows a selected one. As shown in FIG. 2B, the first extractor 210 is arranged for extracting a plurality of feature points 2110 and 2120 from the plurality of 2D images 211-212. The second extractor 220 is arranged for extracting a plurality of landmark points 2610 from the selected generic 3D model 261. After that, the mapping unit 230 is arranged for mapping the plurality of feature points extracted from the plurality of 2D images 211-212 to the plurality of landmark points extracted from the selected generic 3D model 261, so as to generate relationship parameters and a mapping algorithm. The morphing unit 240 is arranged for morphing the selected generic 3D model 261 to generate a personalized 3D model 241 according to the relationship parameters and the mapping algorithm. The refining unit 250 is arranged for iteratively refining the personalized 3D model 261 with the plurality of feature points extracted from the plurality of 2D images (with various postures), and the step of iteratively refining the personalized 3D model is complete when a convergent condition is meet.

Be noted that, the abovementioned relationship parameters may include relationship between the plurality of features points and the plurality of landmark points, and relationship between the plurality of landmark points and non-landmark points of the selected generic 3D model 261; however, this should not be a limitation of the present invention. In addition, the plurality of landmark points extracted from the selected generic 3D model is corresponding to the plurality of feature points extracted from the 2D images, respectively.

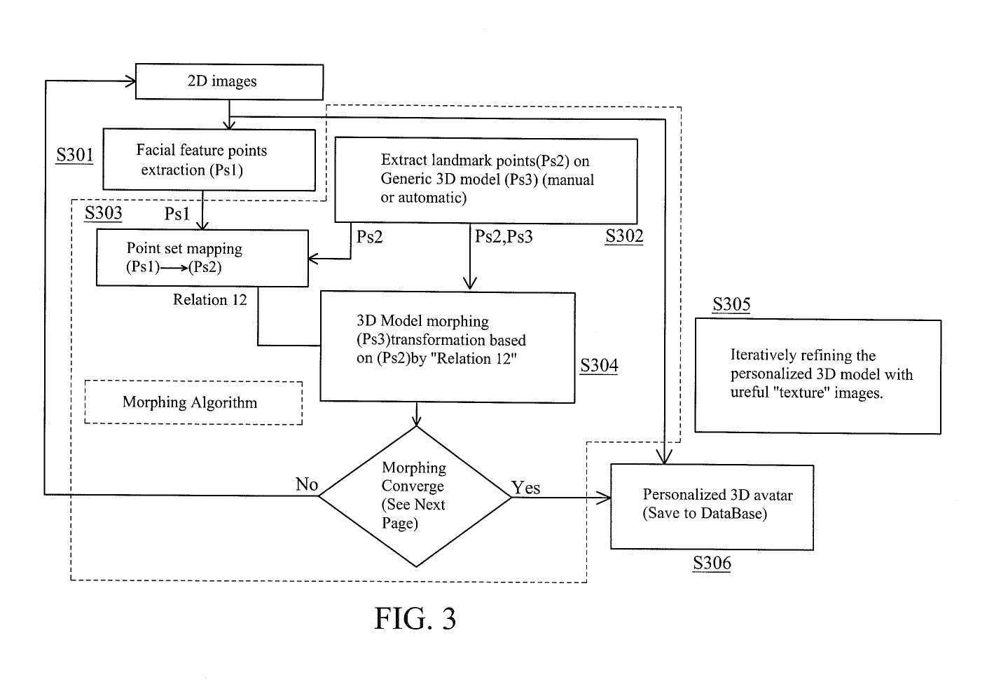

FIG. 3 is a flow chart illustrating a method for generating personalized 3D models using 2D images and generic 3D models according to an embodiment of the present invention. The method includes the following steps:

Step S301: Extracting a plurality of feature points (PS1) from the plurality of 2D images.

Step S302: Extracting a plurality of landmark points (PS2) from the generic 3D model (PS3).

Step S303: Mapping the plurality of feature points (PS1) extracted from the plurality of 2D images to the plurality of landmark points (PS2) extracted from the generic 3D model so as to generate relationship parameters (Relation 12) and a mapping algorithm.

Step S304: Morphing the generic 3D model (PS3) into a personalized 3D model according to the relationship parameters (Relation 12), the plurality of landmark points (PS2), and the mapping algorithm.

Step S305: Iteratively refining the personalized 3D model with the plurality of feature points extracted from the plurality of 2D images.

Step S306: When a convergent condition is met, the step of iteratively refining the personalized 3D model is complete and the personalized 3D model is saved to the 3D model database.

The following equation (1) describes the relationship parameters “Relation12” to find the best fit shape (n landmark points here) of the 3D model after deformation.

A generic 3D coarse shape model described by a “n×1 vector” [Sg]=[g₁, g₂, - - - , gₙ]^{T} with n (ex: n=60) points (each point with 3D coordinates gₓᵢ, g_{yi}, g_{zi}) of landmark points and span basics [V] (a “m×3 matrix”, ex. m=20) are built according to the learned data base off-line, and a generative shape described by a “n×1 vector” [Sp]=[p₁, p₂, - - - , pₙ]^{T} in the 2D image can be described for each point of shape as equation (1):

$$[ \begin{matrix}{p}_{xi} \\ {p}_{yi} \\ 0\end{matrix} ] = s \times [ R ] \times [ \begin{matrix}{p}_{xi}^{g} \\ {p}_{yi}^{g} \\ {p}_{zi}^{g}\end{matrix} ] + [ t ] , \\ where {P}_{3 D ( i )} = [ \begin{matrix}{p}_{xi}^{g} \\ {p}_{yi}^{g} \\ {p}_{zi}^{g}\end{matrix} ] \\ represent a point of personalized 3 D shape , \\ ⇒ [ \begin{matrix}{p}_{xi} \\ {p}_{yi} \\ 0\end{matrix} ] = s \times [ R ] \times ( [ \begin{matrix}{g}_{xi} \\ {g}_{yi} \\ {g}_{zi}\end{matrix} ] + [ p ] \times [ V ] ) + [ t ] , \\ with θ = \{ s , [ R ] , [ t ] , [ p ] \} apply to each point i , \\ ⇒ [ \begin{matrix}{p}_{xi} \\ {p}_{yi} \\ 0\end{matrix} ] = s \times [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \times ( \begin{matrix}\begin{matrix}[ \begin{matrix}{g}_{xi} \\ {g}_{yi} \\ {g}_{zi}\end{matrix} ] + \\ [ {p}_{1} , {p}_{2} , … , {p}_{m} ] \times \end{matrix} \\ [ \begin{matrix}{v}_{11} & {v}_{12} & {v}_{13} \\ … & … & … \\ {v}_{m 1} & {v}_{m 2} & {v}_{m 3}\end{matrix} ]\end{matrix} ) + [ \begin{matrix}tx \\ ty \\ 0\end{matrix} ] \qquad ( 1 )$$

Where θ represents the relationship parameters “Relation 12” between 2D shape in the 2D image [Sp(θ)] and generic coarse 3D face shape [Sg] with n points of landmark points. θ comprises geometric rigid factors s, [R], [t], and non-rigid factor [p], wherein s represents a scaling factor, [R] represents a 3×3 rotation matrix (composed by roll, yaw and pitch), [t] represents a translation factor in the 2D image, and [p] represents deformation parameters which are adjustable parameters to represent a ‘personalized’ face shape, [p] is obtained by an iterative fine-tune optimization algorithm using database constructed by learning all kinds of expressions and various faces from possible sources, the term [P_{3D}]=[P_{3D(1)}, P_{3D(2)}, . . . , P_{3D(n)}]^{T} can be considered as a ‘personalized coarse 3D face shape’ and used in next Step (S304) to get the final personalized 3D model.

Be noted that, the abovementioned Step 304 can be implemented by the following two sub-steps: (1) Sub-step S3041: After getting the ‘personalized coarse 3D face shape’ [P_{3D}] in Step S303, a deformation algorithm as equation (2) is used to transform all vertexes in the generic 3D model into a personalized 3D model.

[V_{3D}^{f}]=[V_{3D}]+[A]×[L_{3D}^{f}−L_{3D}] (2)

<Assume m Vertexs and n Landmarks>
where [V_{3D}] is original 3D model with m vertexs (m×1 vector),
[V_{3D}^{f}] is final 3D model with m vertexs (m×1 vector),
[L_{3D}^{f}−L_{3D}] is landmark difference between final and original model (n×1 vector),
[A] is a m×n weighting matrix created by algorithm and represents adjusting amount in each vertex effected by n points of landmark difference.

The 3D points (60 points) of the coarse 3D face shape are mapped onto the original generic 3D model as control points for deformation calculation. (2) Sub-step S3042: After that, the vertexes and textures of the personalized 3D model are further incrementally updated and deformed in visible region of projected image of the 3D head model by various postures of the plurality of 2D images. When a convergent condition is met, the final personalized 3D model (including vertexes and an integrated texture) is saved to the 3D model database (S306).

Please also note that, the abovementioned Step S302 can be implemented by extracting the plurality of landmark points (PS3) either manually or automatically; however, this should not be a limitation of the present invention.

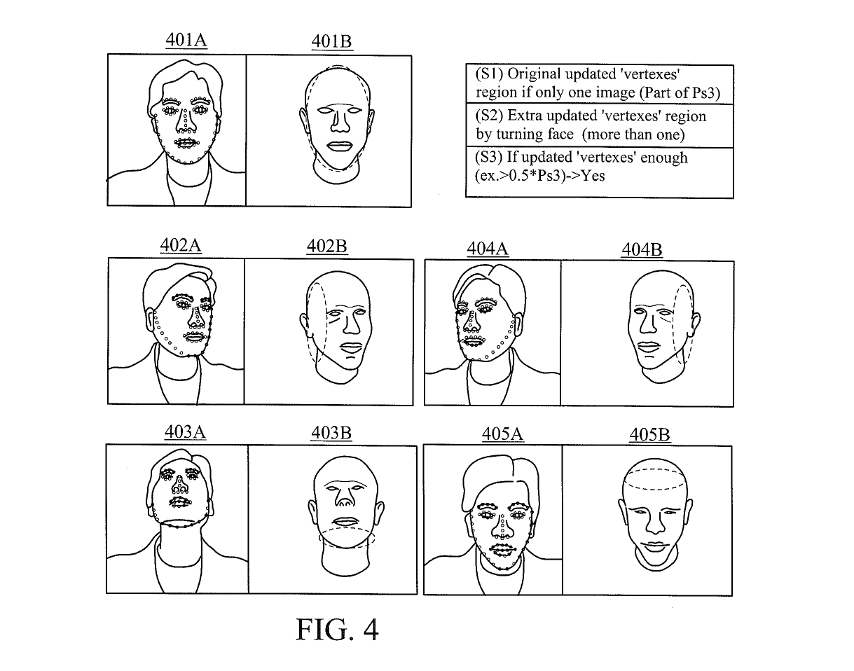

Please refer to FIG. 4. FIG. 4 (including sub-diagrams 401A, 401B, 402A, 402B, 403A, 404B, 405A, and 405B) is a diagram illustrating the details of innovative incremental learning method of generating a personalized 3D model using 2D image(s) and a generic 3D model according to an embodiment of the present invention. As shown in sub-diagrams 401A and 401B, the abovementioned Steps S301-S304 are performed on the 2D image 401A and the generic 3D model 401B, that is, the personalized 3D model is generated when only one 2D image 401A is provided. In other embodiments, the personalized 3D model can be further updated when more 2D images are provided. For example, the rotation of the 2D image 402A is calculated according to the plurality of feature points, the database, and an estimation algorithm to obtain “roll”, “yaw” or “pitch” calculated and based on facial tracking feature points. The generic 3D model in the database is rotated and “new appear vertexes” (marked by dot-curves) are updated according to the rotation of the 2D image 402A to generate the updated 3D model 402B. Similarly, the same process is also performed on the sub-diagrams 403A, 404B, and 405B, and thus vertexes for the right-side cheek, the chin, the left-side cheek, and brow can be updated. Additionally, the texture for the personalized 3D model from the plurality of 2D images can be extracted and attached to the personalized 3D model corresponding to the calculated rotation angle of the head in the 2D images.

Please also note that, the convergent condition of morphing step may be predetermined, for example, as having more than half of the vertexes in the 3D model updated, the reconstruction procedure stops.

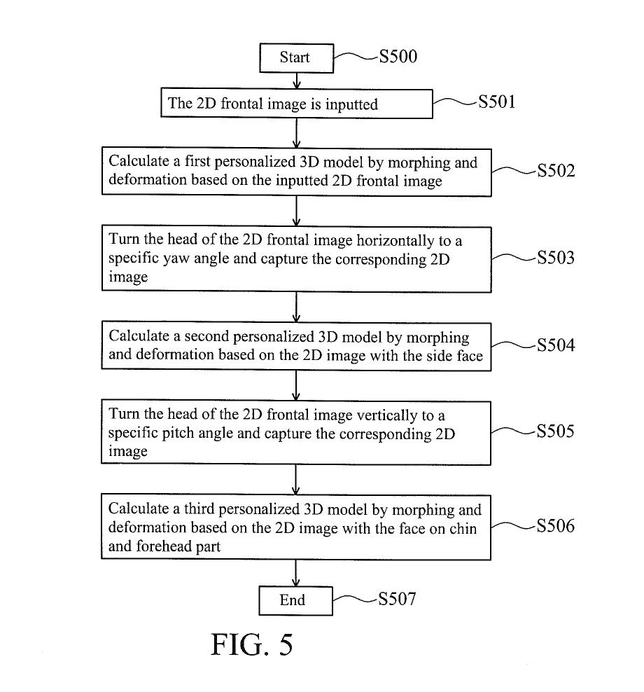

Please refer to FIG. 5. FIG. 5 is an overall design flow illustrating the incremental learning method mentioned in FIG. 4. Please note that the following steps are not limited to be performed according to the exact sequence shown in FIG. 5 if a roughly identical result can be obtained. As shown in FIG. 5, the method includes, but is not limited to, the following steps:

Step S500: Start.

Step S501: The 2D frontal image is inputted.

Step S502: Calculate a first personalized 3D model by morphing and deformation based on the inputted 2D frontal image.

Step S503: Turn the head of the 2D frontal image horizontally to a specific yaw angle and capture the corresponding 2D image.

Step S504: Calculate a second personalized 3D model by morphing and deformation based on the 2D image with the side face.

Step S505: Turn the head of the 2D frontal image vertically to a specific pitch angle and capture the corresponding 2D image.

Step S506: Calculate a third personalized 3D model by morphing and deformation based on the 2D image with the face on chin and forehead part.

Step S507: End.

User must show at least one frontal view to camera once for generating a basic personalized 3D model (Steps S501-S502). After that, the user can turn his head left/right and/or up/down to capture more 2D images with different postures for incremental refining the basic personalized 3D model to a more fidelity one (Steps S503-S504 and Steps S505-S506).

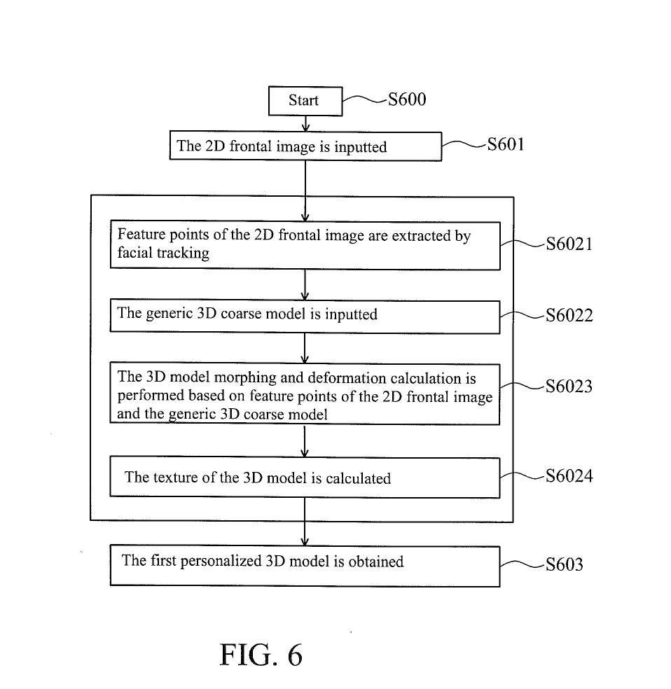

Please refer to FIG. 6. FIG. 6 is a flow chart illustrating the details for calculating a personalized 3D model by morphing and deformation based on 2D frontal image(s). As shown in FIG. 6, the method includes, but is not limited to, the following steps:

Step S600: Start.

Step S601: The 2D frontal image is inputted.

Step S6021: Feature points of the 2D frontal image are extracted by facial tracking.

Step S6022: The generic 3D coarse model is inputted.

Step S6023: The 3D model morphing and deformation calculation is performed based on feature points of the 2D frontal image and the generic 3D coarse model.

Step S6024: The texture of the 3D model is calculated.

Step S603: The first personalized 3D model is obtained.

Those skilled in the art can readily understand how each element operates by combining the steps shown in FIG. 6, the steps S501-S502 shown in FIG. 5 and the elements shown in sub-diagrams 401A and 401B, and the elements shown in FIG. 2 and further description is omitted here for brevity. In one embodiment, the step S6021 is executed by the first extractor 210, the step S6022 is executed by the 3D model database 260, the step S6023 is executed by the morphing unit 240, and the step S6024 is executed by the refining unit 250. Please also note that the steps shown in FIG. 6 illustrate the details of the steps S501-S502 shown in FIG. 5.

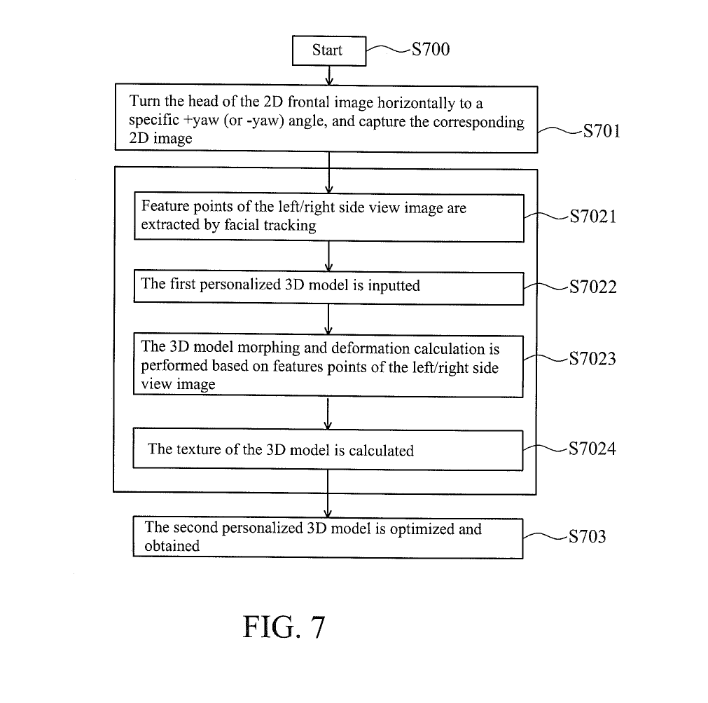

Please refer to FIG. 7. FIG. 7 is a flow chart illustrating the details for calculating a personalized 3D model by morphing and deformation based on left/right side view image(s). As shown in FIG. 7, the method includes, but is not limited to, the following steps:

Step S700: Start.

Step S701: Turn the head of the 2D frontal image horizontally to a specific +yaw (or −yaw) angle, and capture the corresponding 2D image.

Step S7021: Feature points of the left/right side view image are extracted by facial tracking.

Step S7022: The first personalized 3D model is inputted.

Step S7023: The 3D model morphing and deformation calculation is performed based on features points of the left/right side view image.

Step S7024: The texture of the 3D model is calculated.

Step S703: The second personalized 3D model is optimized and obtained.

Those skilled in the art can readily understand how each element operates by combining the steps shown in FIG. 7, the steps S503-S504 shown in FIG. 5, the elements shown in sub-diagrams 402A, 402B, 404A, and 404B, and the elements shown in FIG. 2 and further description is omitted here for brevity. In one embodiment, the step S7021 is executed by the first extractor 210, the step S7022 is executed by the 3D model database 260, the step S7023 is executed by the morphing unit 240, and the step S7024 is executed by the refining unit 250. Please also note that the steps shown in FIG. 7 illustrate the details of the steps S503-S504 shown in FIG. 5.

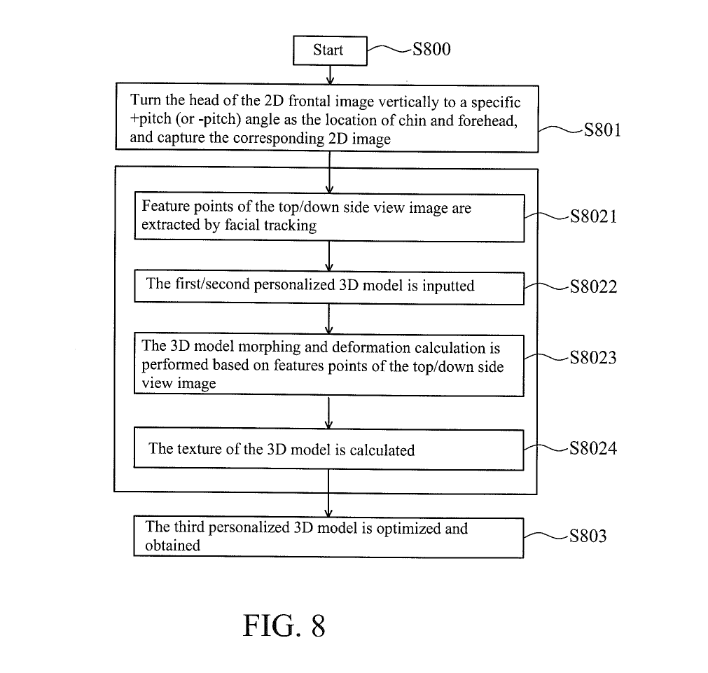

Please refer to FIG. 8. FIG. 8 is a flow chart illustrating the details for calculating a personalized 3D model by morphing and deformation based on top/down view image(s). As shown in FIG. 8, the method includes, but is not limited to, the following steps:

Step S800: Start.

Step S801: Turn the head of the 2D frontal image vertically to a specific +pitch (or −pitch) angle as the location of chin and forehead, and capture the corresponding 2D image.

Step S8021: Feature points of the top/down side view image are extracted by facial tracking.

Step S8022: The first/second personalized 3D model is inputted.

Step S8023: The 3D model morphing and deformation calculation is performed based on features points of the top/down side view image.

Step S8024: The texture of the 3D model is calculated.

Step S803: The third personalized 3D model is optimized and obtained.

Those skilled in the art can readily understand how each element operates by combining the steps shown in FIG. 8, the steps S505-S506 shown in FIG. 5, the elements shown in sub-diagrams 403A, 403B, 405A, and 405B, and the elements shown in FIG. 2 and further description is omitted here for brevity. In one embodiment, the step S8021 is executed by the first extractor 210, the step S8022 is executed by the 3D model database 260, the step S8023 is executed by the morphing unit 240, and the step S8024 is executed by the refining unit 250. Please also note that the steps shown in FIG. 8 illustrate the details of the steps S505-S506 shown in FIG. 5.

Please note that, in another embodiment, an animation system may further include an audio extractor for providing an audio. A 3D video generator of the animation system may still use the method for generating a personalized 3D model using a plurality of 2D images and a generic 3D model. Finally, a video and audio combiner may combine the audio and a 3D video with the personalized 3D model to generate a clip. For example, a face tracking is performed on a real time 2D image stream and the plurality of feature points on the face of the 2D image stream is obtained. After that, a 3D video having a personalized 3D model with facial expression is generated according to the feature points extracted by face tracking and the generic 3D model. Finally, a video/audio recording mechanism is adopted for combining the extracted audio and the 3D video having the personalized 3D model to generate a medium clip.

The abovementioned embodiments are presented merely to illustrate practicable designs of the present invention, and should be considered to be limitations of the scope of the present invention. In summary, by adopting the method for generating personalized 3D models using 2D images and generic 3D models and a related animation system using the same method of the present invention, a 3D model with personalized effects can be achieved. In addition, more 2D images with left/right side views and/or top/down side views can be inputted in order to meet a convergent condition more quickly, which can provide more convenience to users. Besides, by adopting the concept of the present invention, textures can be attached from the plurality of 2D images to the personalized 3D model, which can make the personalized 3D model(s) more lifelike and more accurate.

Those skilled in the art will readily observe that numerous modifications and alterations of the device and method may be made while retaining the teachings of the invention.

What is claimed is:

1. A method for generating a personalized 3D model using a plurality of 2D images and a generic 3D model, comprising:
extracting a plurality of feature points from the plurality of 2D images;
extracting a plurality of landmark points from the generic 3D model;
mapping the plurality of feature points extracted from the plurality of 2D images to the plurality of landmark points extracted from the generic 3D model so as to generate relationship parameters and a mapping algorithm; and
morphing the generic 3D model into a personalized 3D model according to the relationship parameters, the plurality of landmark points, and the mapping algorithm.

2. The method of claim 1, further comprising:
iteratively refining the personalized 3D model with the plurality of feature points extracted from the plurality of 2D images; and
when a convergent condition is met, the step of iteratively refining the personalized 3D model is complete and the personalized 3D model is saved to the 3D model database.

3. The method of claim 1, wherein the plurality of landmark points is extracted from the generic 3D model automatically.

4. The method of claim 1, further comprising:
extracting a texture for the personalized 3D model from the plurality of 2D images; and
attaching the texture to the personalized 3D model.

5. The method of claim 1, wherein the plurality of 2D images comprises at least one frontal image.

6. The method of claim 1, wherein the plurality of 2D images comprises at least one left side view image and/or right side view image.

7. The method of claim 1, wherein the plurality of 2D images comprises at least one top view image and/or down view image.

8. A method for generating a personalized 3D model using a plurality of 2D images and a generic 3D model, comprising:
extracting a plurality of feature points from the plurality of 2D images;
calculating each rotation of a head of the plurality of 2D images according to the plurality of feature points, a 3D model database and an estimation algorithm;
updating incrementally a generic 3D model according to the rotation of the head of the plurality of 2D images at various directions in order to generate an updated 3D model;
extracting a plurality of landmark points from the updated 3D model;
mapping the plurality of feature points extracted from the plurality of 2D images to the plurality of landmark points extracted from the updated 3D model so as to generate relationship parameters an a mapping algorithm; and
morphing the updated 3D model into a personalized 3D model according to the plurality of rotation angles, the relationship parameters, and the mapping algorithm.

9. The method of claim 8, further comprising:
iteratively refining the personalized 3D model with the plurality of feature points extracted from the plurality of 2D images; and
when a convergent condition is met, the step of iteratively refining the personalized 3D model is complete and the personalized 3D model is saved to the 3D model database.

10. The method of claim 8, wherein the plurality of landmark points is extracted from the generic 3D model automatically.

11. The method of claim 8, further comprising:
extracting a texture for the personalized 3D model from the plurality of 2D images; and
attaching the texture to the personalized 3D model.

12. The method of claim 8, wherein the plurality of 2D images comprises at least one frontal image.

13. The method of claim 8, wherein the plurality of 2D images comprises at least one left side view image and/or right side view image.

14. The method of claim 8, wherein the plurality of 2D images comprises at least one top view image and/or down view image.

15. A personalized 3D model generating system, comprising:
a 3D model database, for arranged for storing a plurality of generic 3D models;
a first extractor, for arranged for extracting a plurality of feature points from the plurality of 2D images;
a second extractor, for arranged for extracting a plurality of landmark points from the generic 3D model;
a mapping unit, for arranged for mapping the plurality of feature points extracted from the plurality of 2D images to the plurality of landmark points extracted from the generic 3D model, so as to generate relationship parameters and a mapping algorithm; and
a morphing unit, for arranged for morphing the generic 3D model to generate a personalized 3D model according to the relationship parameters and the mapping algorithm.

16. The personalized 3D model generating system of claim 15, further comprising:
a refining unit, for arranged for iteratively refining the personalized 3D model with the plurality of feature points extracted from the plurality of 2D images;
where when a convergent condition is met, the refining unit stops working and the personalized 3D model is saved to the 3D model database.

17. The personalized 3D model generating system of claim 15, wherein the second extractor extracts the plurality of landmark points from the generic 3D model automatically.

18. The personalized 3D model generating system of claim 15, wherein the plurality of 2D images comprises at least one frontal image.

19. The personalized 3D model generating system of claim 15, wherein the plurality of 2D images comprises at least one left side view image and/or right side view image.

20. The personalized 3D model generating system of claim 15, wherein the plurality of 2D images comprises at least one top view image and/or down view image.
